(19) United States
(12) Patent Application Publication
(10) Pub. No.: US 2016/0367844 A1
(43) Pub. Date: Dec. 22, 2016

(54) Anti-Fall Device with Visible Inspection Function

(71) Applicants: Kai Chieh Yang, Taichung City (TW); Aerohook Technology Co., Ltd., Taichung City (TW)

(72) Inventors: Kai Chieh Yang, Taichung City (TW); Tzu-Sen Lai, Taichung City (TW); Yang Tsung Chen, Taichung City (TW)

(21) Appl. No.: 14/740,267

(22) Filed: Jun. 16, 2015

(51) Int. Cl. A62B 35/00

(52) U.S. Cl. CPC A62B 35/0093; A62B 35/0075

(57) ABSTRACT

An anti-fall device includes an outer casing which has a receiving chamber, at least a window formed at a sidewall of the outer casing to communicate with the receiving chamber, and a braking member adjacent to the window, and a braking assembly which includes at least a centrifugal actuator supported within the receiving chamber to be moved to selectively engage with the braking member between a locked position and an unlocked position. The centrifugal actuator is aligned with the window, such that the centrifugal actuator of the braking assembly is visibly seen through the window to check whether the centrifugal actuator is actuated at the locked position or the unlocked position.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention provides an anti-fall device that is able to implement real-time quality control for process.

Description of Related Arts

The latest anti-fall device, as disclosed by US Patent No 2013/0105247, has been widely used in construction sites, chimney, roof repairs, or other operation constructions at heights to mitigate the effects of gravity and falling.

In particular, US Patent No 2013/0105247 disclosed a self-retracting lifeline which comprises a drum, a rotor, a motor spring received in a bracket, wherein an axel is inserted into the bracket through the aperture to the aperture through the drum and the rotor. In addition, the bracket is enclosed by a housing.

During the quality control testing, the free end of lifeline is pulled rapidly to inspect whether the lifeline is locked or not. However, when there is any abnormal condition, it is impossible to immediately find out where the problem is. Generally speaking, the common problem of the existing anti-fall device is either the rotor or the locking mechanism. In other words, the housing of the anti-fall device must be disassembled to inspect the rotational movement of the rotor and the actuation of the locking mechanism, which brings inconvenience for the inspector for quality control determination and troubleshooting. A need exists for a quick visible inspection that retains all of its safety attributes and while allowing the inspector to quickly inspect the anti-fall device before it is used.

### SUMMARY OF THE PRESENT INVENTION

The present invention provides an anti-fall device with visible inspection function. The anti-fall device comprises an outer casing, a drum assembly, a rotor, and a coil spring.

The outer casing comprises a first casing body and a second casing body coupled with each other to form a receiving chamber, wherein the first casing body and the second casing body have a first center through slot and a second center through slot respectively. A supporting shaft is extended between the first center through slot and the second center through slot through the receiving chamber. The first casing body further has at least a window formed at a sidewall of the first casing body to communicate with the receiving chamber and comprises at least a braking member extended from an inner side of the sidewall of the first casing body at a position adjacent to the window.

The drum assembly comprises a rotatable drum rotatably supported in the receiving chamber of the outer casing, wherein a life saving rope is wound around the rotatable drum.

The rotor is driven to rotate by the rotatable drum, wherein a braking assembly is operatively coupled with the rotor and is actuated between a locked position and an unlocked position.

The coil spring is coupled between the rotatable drum and the outer casing for retracting the life saving rope around the rotatable drum.

Accordingly, when a free end of the life saving rope is rapidly pulled out from the outer casing to generate an instant centrifugal force to the braking assembly, the braking assembly is actuated by the centrifugal force to move from the unlocked position to the locked position to lock up a rotational movement of the rotor so as to stop a rotational movement of the rotatable drum for instantly generating a tightening effect of the life saving rope. In any abnormal condition of the braking assembly, the braking assembly is visibly seen through the windows to check whether the braking assembly is located at the locked position or the normal unlocked position. Therefore a solution can be found shortly to achieve the goal of increasing and controlling the quality and to improve on the disadvantages of the conventional anti-fall devices in quality control testing.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of an anti-fall device according to a preferred embodiment of the present invention.

FIG. 2 is a perspective view a first casing body of an outer casing according to the above preferred embodiment of the present invention.

FIG. 3 is a front perspective view the anti-fall device according to the above preferred embodiment of the present invention.

FIG. 4 is a rear perspective view the anti-fall device according to the above preferred embodiment of the present invention.

FIG. 5 is a sectional view of the anti-fall device according to the above preferred embodiment of the present invention, illustrating the normal unlocked position of the braking assembly.

FIG. 6 is a sectional view of the anti-fall device according to the above preferred embodiment of the present invention, illustrating the locked position of the braking assembly.

FIG. 7 is another sectional view of the anti-fall device according to the above preferred embodiment of the present invention, illustrating the normal unlocked position of the braking assembly.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

With the aids of the Figures shown below, the content of techniques, features, and embodiments of the present invention is herein described, so as for the examiners to further understand the present invention.

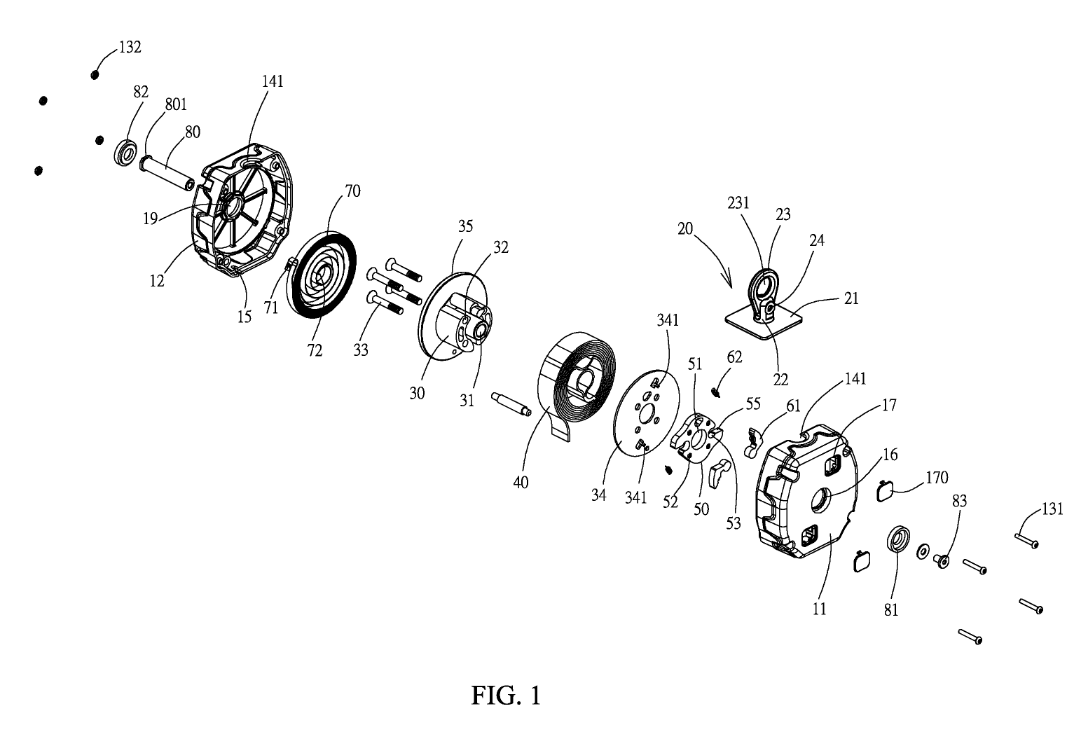

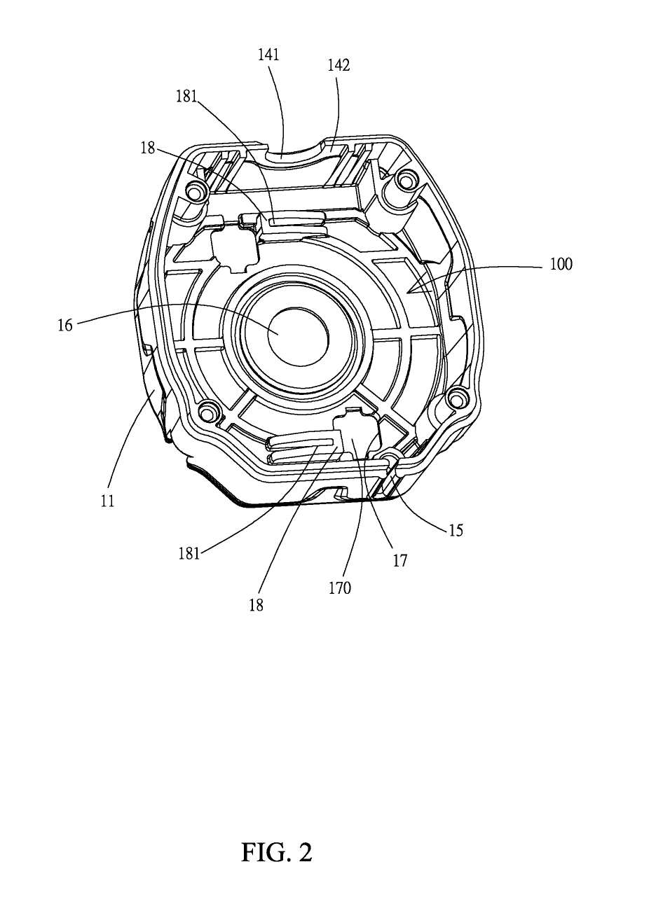

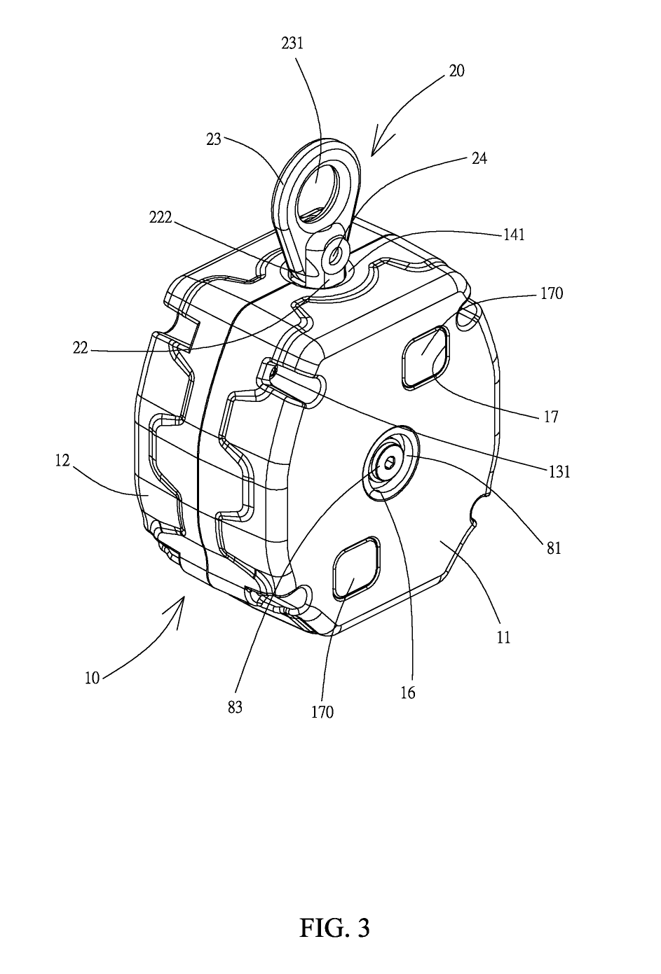

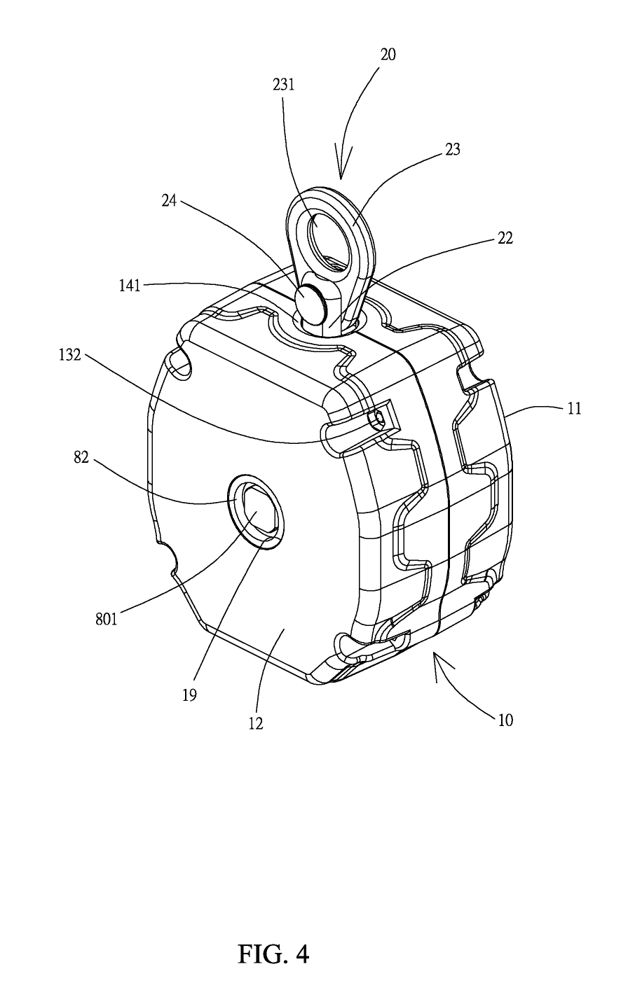

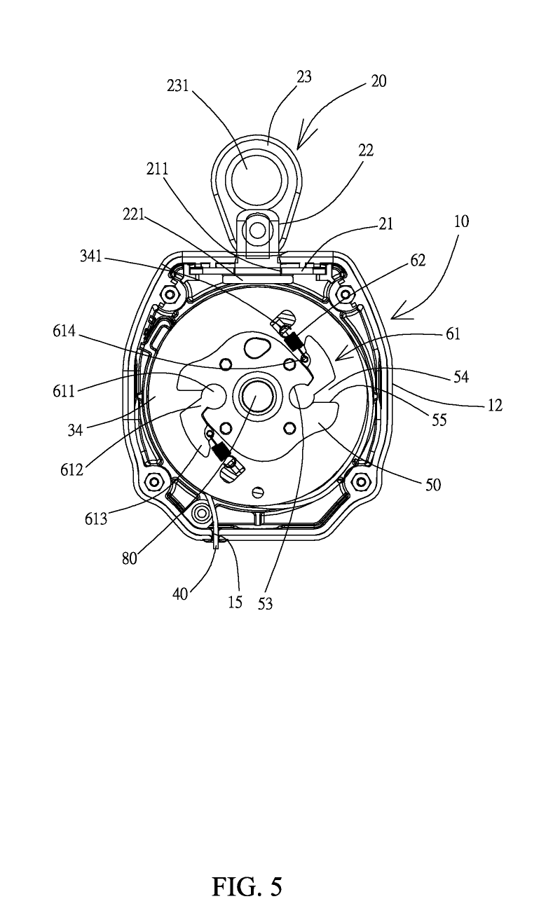

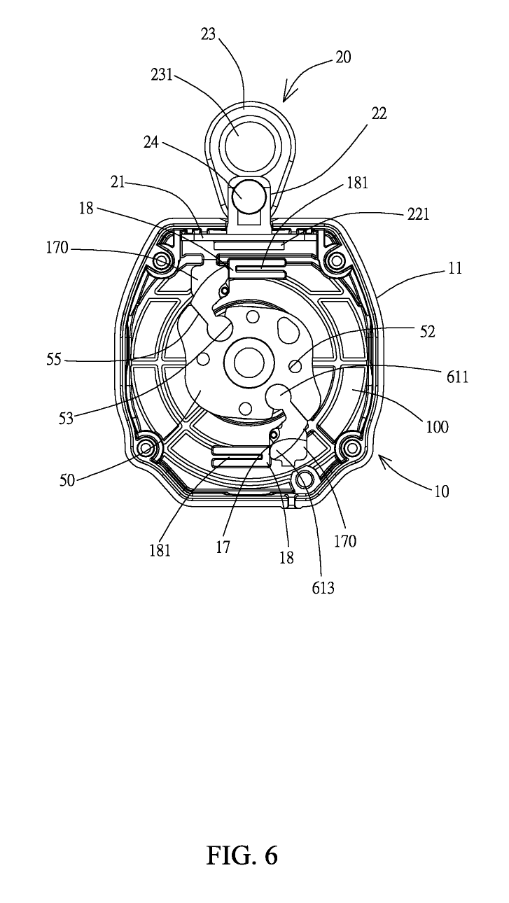

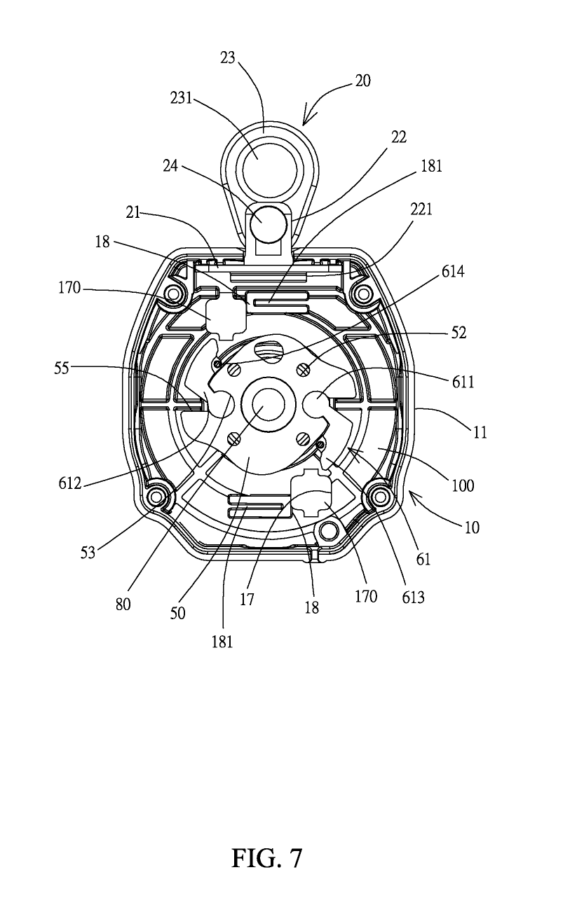

Referring to FIG. 1 to FIG. 7 of the drawings, an anti-fall device according to a preferred embodiment of the present invention is illustrated, wherein the ant-fall device comprises an outer casing 10 having a receiving chamber 100. The outer casing 10 comprises a first casing body 11 and a second casing body 12 coupled with each other via a casing fastener to form the receiving chamber 100 therewithin. The casing fastener comprises a plurality of casing screws 131 spacedly extended from the first casing body 11 to the second casing body 12, and a plurality of casing nuts 132 detachably coupled with the casing screws 131 to securely couple the first casing body 11 with the second casing body 12. The outer casing 10 further has an upper slot 141 formed at a top side thereof and a coupling cavity 142 formed under the upper slot 141 within the receiving chamber 100 to communicate with the upper slot 141 when the first casing body 11 and the second casing body 12 is coupled with each other. The second casing body 12 further has a bottom slot 15 formed at a bottom side thereof to communicate with the receiving chamber 100. The first casing body 11 further has a first center through slot 16 formed at a center of a sidewall thereof, and at least a window 17 formed at the sidewall of the first casing body 11 to communicate with the receiving chamber 100. Preferably, two windows 17 are symmetrically formed at the sidewall of the first casing body 11 with respect to the center through slot 16 thereof. Accordingly, the first casing body 11 further comprises a window cover 170 which is made of transparent material and is sealed at the window 17 such that the receiving chamber 100 can be visibly seen through the window 17. Alternatively, the window cover 170 can be made of opaque material and can be movably coupled at the sidewall of the first casing body 11 to selectively open or close the window 17, such that the window cover 170 can be slidably coupled at the sidewall of the first casing body 11 (such as an existing window assembly) to open or close the window 17, or can be pivotally coupled at the sidewall of the first casing body 11 (such as a door assembly) to open or close the window 17, so as to enable the receiving chamber 100 to be seen through an exterior of the outer casing 10. The first casing body 11 further comprises two braking members 18 extended from an inner side of the sidewall of the first casing body 11 at a position adjacent to the windows 17 respectively. Each of the braking members 18, having a U-shape, forms a damping groove 181 thereat for absorbing vibration of the braking member 18, wherein each of the braking members 18 has an opened end and a closed end that the damping groove 181 is formed between the opened end and the closed end. The second casing body 12 further has a second center through slot 19 formed at a center of a sidewall of the second casing body 12 to align with the first center through slot 16 of the first casing body 11 through the receiving chamber 100.

The anti-fall device further comprises a shaft assembly which comprises a supporting shaft 80 rotatably extended between the first center through slot 16 and the second center through slot 19 through the receiving chamber 100. The shaft assembly further comprises a first bearing 81 supported at a first end of the supporting shaft 80 at the first center through slot 16 of the first casing body 11 and a second bearing 82 supported at an opposed second end of the supporting shaft 80 at the second center through slot 19 of the second casing body 12. Preferably, the supporting shaft 80 has an enlarged shaft cap 801 formed at the second end thereof, wherein when the supporting shaft 80 is slidably passed through the second center through slot 19 of the second casing body 12, the second bearing 82 is pressed by the shaft cap 801 to retain the second bearing 82 at the second center through slot 19 of the second casing body 12. The shaft assembly further comprises a shaft fastener 83 coupled at the first end of the supporting shaft 80 to retain the first bearing 81 at the first center through slot 16 of the first casing body 11. It is worth mentioning that the rotational movement of supporting shaft 80 is adjustable via the shaft fastener 83 that the supporting shaft 80 can be rotated slower when the shaft fastener 83 is tightly fastened with the supporting shaft 80.

The anti-fall device further comprises a catch frame 20 which comprises coupling platform 21 coupled at the coupling cavity 142, wherein the coupling platform 21 has a coupling hole 221 aligned with the upper slot 141 of the outer casing 10. Accordingly, a diameter of the coupling hole 221 is smaller than a diameter of the upper slot 141. The catch frame 20 further comprises a rotatable axle 22 extended through the coupling hole 221 of the coupling platform 21, and a lifting lug 23 coupled at the rotatable axle 22. The rotatable axle 22 has an enlarged shoulder portion 222 at a bottom portion of the rotatable axle 22, wherein the shoulder portion 222 of the rotatable axle 22 is located underneath the coupling platform 21. The rotatable axle 22 further has a lug slot 222 downwardly extended from a top end of the rotatable axle 22 at a radial direction thereof, wherein a bottom portion of the lifting lug 23 is engaged with the lug slot 222 via a lug fastener 24. The lifting lug 23 has a lug hole 231 formed at an upper portion thereof. It is worth mentioning that the lifting lug 23 is rotatably coupled at the rotatable axle 22 via the lug fastener 24 while the rotatable axle 22 is rotatably coupled at the coupling platform 21, such that the lug hole 231 can be selectively adjusted its orientation in three dimensional manner according to the need of the lifting lug 23.

The anti-fall device further comprises a drum assembly which comprises a rotatable drum 30 supported in the receiving chamber 100 of the outer casing 10, wherein the rotatable drum 30 has a center drum slot 31 for the supporting shaft 80 passing therethrough, and a plurality of eccentric through slots 32, preferably four, radially and symmetrically located with respect to the center drum slot 31. The drum assembly further comprises a plurality of drum screws 33 extended through the eccentric through slots 32 respectively. The drum assembly further comprises a first drum panel 34 coaxially coupled with the rotatable drum 30 via the drum screws 33, and a second drum panel 35 integrally and radially extended from the rotatable drum 30, such that the rotatable drum 30 is sandwiched between the first drum panel 34 and the second drum panel 35. It is worth mentioning that a diameter of the rotatable drum 30 is smaller than a diameter of each of the first drum panel 34 and the second drum panel 35. The first drum panel 34 further has two first spring seats 341 symmetrically formed at an inner side of the first drum panel 34. The anti-fall device further comprises a life saving rope 40 wounded around the rotatable drum 30, wherein a free end of the life saving rope 40 is slidably extended out of the receiving chamber 100 through the bottom slot 15 of the outer casing 10. It is worth mentioning that a rope restricting cavity is formed between the first drum panel 34 and the second drum panel 35, such that the life saving rope 40 is wounded around the rotatable drum 30 between the first drum panel 34 and the second drum panel 35 within the rope restricting cavity therebetween.

The anti-fall device further comprises a rotor 50 supported in the receiving chamber 100 of the outer casing 10, wherein the rotor 50 has a center rotor slot 51 for the supporting shaft 80 passing therethrough. The rotor 50 further has a plurality of eccentric threaded slots 52, preferably four, radially and symmetrically located with respect to the center rotor slot 51, wherein the drum screws 33 are rotatably engaged with the eccentric threaded slots 52 respectively to couple the rotor 50 at an outer side of the first drum panel 34. The rotor 50 further has a plurality of eccentric rotor slots 53 radially and symmetrically located with respect to the center rotor slot 51 and a plurality of rotor channels 54 radially and outwardly extended from the eccentric rotor slots 53 respectively. The rotor 50 further comprises a plurality of blocking arms 55 radially, outwardly and symmetrically extended from a peripheral edge of the rotor 50, wherein the eccentric rotor slots 53 are located at inner ends of the blocking arms 55 respectively and the rotor channels 54 are located along the blocking arms 55 respectively.

The anti-fall device further comprises a braking assembly which comprises two centrifugal actuators 61 and two resilient elements 62 which are preferably two compression springs. Each of the centrifugal actuators 61 has a pivot portion 611 pivotally engaged with the eccentric rotor slot 53, a crank portion 612 extended from the pivot portion 611 to align with the rotor channel 54, and a braking portion 613 extended from the crank portion 612, wherein the braking portion 613 is a free end portion of the braking member 61. Each of the centrifugal actuators 61 further comprises a second spring seat 614 formed at an inner side of the braking portion 613, wherein two ends of each of the resilient elements 62 are coupled at the first spring seat 341 and the second spring seat 614 respectively to apply a spring force against the braking member 61. Accordingly, each of the resilient elements 62 applies a spring pulling force against the braking member 61 to pull the crank portion 612 away from the blocking arm 55 and to pull the braking portion 613 to lie on the peripheral edge of the rotor 50 as the normal unlocked position.

The anti-fall device further comprises a coil spring 70 supported in the receiving chamber 100 of the outer casing 10, wherein an outer end of the coil spring 70 is affixed to the outer casing 10 and an inner end of the coil spring 70 is affixed to the rotatable drum 30 for applying a retraction spring force at the rotatable drum 30 to retract the life saving rope 40 therearound.

According to the preferred embodiment, a user is able to couple the lifting lug 23 to a safety location and to couple the free end of the life saving rope 40 at a harness worn by the user who works above ground level. Therefore, the life saving rope 40 is free to pull out from the outer casing 10 and to retract back to the outer casing 10 to rotate the rotatable drum 30 while the rotor 50 is free to rotate about the supporting shaft 80. In case of a fall, the free end of the life saving rope 40 is rapidly pulled out from the outer casing 10 to generate an instant centrifugal force to the centrifugal actuators 61, wherein the centrifugal force is larger than the spring pulling forces of the resilient elements 62, to pivotally move the centrifugal actuators 61. Accordingly, the pivot portions 611 of the centrifugal actuators 61 are pivotally moved at the eccentric rotor slots 53 until the crank portions of the centrifugal actuators 61 are blocked by the blocking arms 55, such that the braking portions 613 of the centrifugal actuators 61 are engaged with closed ends of the braking members 18 respectively. As a result, the braking portions 613 of the centrifugal actuators 61 are stuck between the braking members 18 of the outer casing 10 and the blocking arms 55 of the rotor 50 as the locked position to lock up the rotation of the rotor 50 so as to tighten the life saving rope 40. In other words, the anti-fall device is able to simultaneously trigger to instantly generate a tightening effect of the life saving rope 40 in case of a fall.

Accordingly, for quality control test, the free end of the life saving rope 40 can be rapidly pulled out from the outer casing 10 to test whether the braking assembly is malfunctioned or not. It is worth mentioning that the centrifugal actuators 61 are aligned with the windows 17 when the centrifugal actuators 61 are moved at the locked position. In any abnormal condition of the braking assembly, the centrifugal actuators 61 can be visibly seen through the windows 17 to check whether the centrifugal actuators 61 are located at the locked position or the normal unlocked position. In other words, the user does not have to disassemble the outer casing 10 to inspect the condition of the braking assembly. Therefore a solution can be found shortly to achieve the goal of increasing and controlling the quality and to improve on the disadvantages of the conventional anti-fall devices in quality control testing.

All in all, the present invention can certainly bring a revolutionary efficiency of quality control, and the structure arrangement thereof is truly unprecedented to meet patent application requirements.

However, the above descriptions are only a preferred embodiment of the present invention, and all equivalent varieties and modifications based on the appended claims of the present invention are within the scope of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An anti-fall device, comprising:
an outer casing having a receiving chamber and a window formed at a sidewall of said outer casing that said receiving chamber is visibly seen through said window, wherein said outer casing further has at least a braking member extended from an inner side of said sidewall of said outer casing at a position adjacent to said window;
a drum assembly which comprises a rotatable drum rotatably supported in said receiving chamber of said outer casing;
a life saving rope retractably wound around said rotatable drum;
a rotor received in said receiving chamber and being driven to rotate by said rotatable drum; and
a braking assembly which comprises at least a centrifugal actuator supported within said receiving chamber, wherein said centrifugal actuator is movably coupled at said rotor to move between an unlocked position that said rotatable drum is free to rotate within said receiving chamber and a locked position that said centrifugal actuator is moved to engage with said braking member to lock up a rotation of said rotor so as to tighten said life saving rope, wherein said centrifugal actuator is align with said window at said locked position, such that said centrifugal actuator is visibly seen through said window to check whether said centrifugal actuator is actuated at said locked position or said unlocked position.

2. The anti-fall device, as recited in claim 1, wherein said outer casing further comprises a window cover which is made of transparent material and is sealed at said window, such that said centrifugal actuator is visibly seen through said window cover to check whether said centrifugal actuator is actuated at said locked position or said unlocked position.

3. The anti-fall device, as recited in claim 1, wherein said outer casing further comprises a first casing body and a second casing body coupled with each other to form said receiving chamber, wherein said window and said braking member are formed at an inner side of said first casing body.

4. The anti-fall device, as recited in claim 2, wherein said outer casing further comprises a first casing body and a second casing body coupled with each other to form said receiving chamber, wherein said window and said braking member are formed at an inner side of said first casing body.

5. The anti-fall device, as recited in claim 1, wherein said outer casing further has a bottom slot communicating with said receiving chamber that a free end of said life saving rope is extended out of said receiving chamber through said bottom slot, such that when said free end of said life saving rope is rapidly pulled to generate an instant centrifugal force to said braking assembly, said centrifugal actuator is actuated to move from said unlocked position to said locked position.

6. The anti-fall device, as recited in claim 4, wherein said outer casing further has a bottom slot communicating with said receiving chamber that a free end of said life saving rope is extended out of said receiving chamber through said bottom slot, such that when said free end of said life saving rope is rapidly pulled to generate an instant centrifugal force to said braking assembly, said centrifugal actuator is actuated to move from said unlocked position to said locked position.

7. The anti-fall device, as recited in claim 1, wherein said braking member, having a U-shape, has a damping groove thereat for absorbing vibration of said braking member, an opened end, and a closed end that said damping groove is formed between said opened end and said closed end, wherein said centrifugal actuator is actuated to engage with said closed end of said braking member at said locked position.

8. The anti-fall device, as recited in claim 6, wherein said braking member, having a U-shape, has a damping groove thereat for absorbing vibration of said braking member, an opened end, and a closed end that said damping groove is formed between said opened end and said closed end, wherein said centrifugal actuator is actuated to engage with said closed end of said braking member at said locked position.

9. The anti-fall device, as recited in claim 1, further comprising a supporting shaft supported within said receiving chamber of said outer casing, wherein said rotatable drum and said rotor are rotatably supported by said supporting shaft.

10. The anti-fall device, as recited in claim 6, further comprising a supporting shaft supported within said receiving chamber of said outer casing, wherein said rotatable drum and said rotor are rotatably supported by said supporting shaft.

11. The anti-fall device, as recited in claim 1, further comprising a catch frame, wherein said outer casing further has an upper slot formed at a top side thereof, wherein said catch frame is coupled with said outer casing at said upper slot.

12. The anti-fall device, as recited in claim 6, further comprising a catch frame, wherein said outer casing further has an upper slot formed at a top side thereof, wherein said catch frame is coupled with said outer casing at said upper slot.

13. The anti-fall device, as recited in claim 1, wherein said drum assembly further comprises a first drum panel coaxially coupled with said rotatable drum, and a second drum panel integrally and radially extended from said rotatable drum, such that said rotatable drum is sandwiched between said first drum panel and said second drum panel to wind said life saving rope around said rotatable drum between said first drum panel and said second drum panel, wherein said rotor is coupled at an outer side of said first drum panel.

14. The anti-fall device, as recited in claim 6, wherein said drum assembly further comprises a first drum panel coaxially coupled with said rotatable drum, and a second drum panel integrally and radially extended from said rotatable drum, such that said rotatable drum is sandwiched between said first drum panel and said second drum panel to wind said life saving rope around said rotatable drum between said first drum panel and said second drum panel, wherein said rotor is coupled at an outer side of said first drum panel.

15. The anti-fall device, as recited in claim 1, wherein said braking assembly further comprises a resilient element having two ends affixed to said drum assembly and said centrifugal actuator respectively to retain said centrifugal actuator at said unlocked position.

16. The anti-fall device, as recited in claim 6, wherein said braking assembly further comprises a resilient element having two ends affixed to said drum assembly and said centrifugal actuator respectively to retain said centrifugal actuator at said unlocked position.

17. The anti-fall device, as recited in claim 1, wherein said rotor further has a plurality of eccentric rotor slots radially and symmetrically located with respect to a center rotor slot and a plurality of rotor channels radially and outwardly extended from said eccentric rotor slots respectively, wherein said rotor further comprises a plurality of blocking arms radially, outwardly and symmetrically extended from a peripheral edge of said rotor, wherein said eccentric rotor slots are located at inner ends of said blocking arms respectively and said rotor channels are located along said blocking arms respectively, wherein said centrifugal actuator is actuated to be stuck between said braking member and said blocking arm of said rotor at said locked position.

18. The anti-fall device, as recited in claim 6, wherein said rotor further has a plurality of eccentric rotor slots radially and symmetrically located with respect to a center rotor slot and a plurality of rotor channels radially and outwardly extended from said eccentric rotor slots respectively, wherein said rotor further comprises a plurality of blocking arms radially, outwardly and symmetrically extended from a peripheral edge of said rotor, wherein said eccentric rotor slots are located at inner ends of said blocking arms respectively and said rotor channels are located along said blocking arms respectively, wherein said centrifugal actuator is actuated to be stuck between said braking member and said blocking arm of said rotor at said locked position.

19. The anti-fall device, as recited in claim 17, wherein said centrifugal actuator has a pivot portion pivotally engaged with said eccentric rotor slot, a crank portion extended from said pivot portion to align with said rotor channel, and a braking portion extended from said crank portion, wherein said pivot portions of said centrifugal actuator is pivotally moved at said eccentric rotor slot until said crank portion of said centrifugal actuator is blocked by said blocking arm, such that said braking portion of said centrifugal actuator is engaged with said braking member at said locked position.

20. The anti-fall device, as recited in claim 18, wherein said centrifugal actuator has a pivot portion pivotally engaged with said eccentric rotor slot, a crank portion extended from said pivot portion to align with said rotor channel, and a braking portion extended from said crank portion, wherein said pivot portions of said centrifugal actuator is pivotally moved at said eccentric rotor slot until said crank portion of said centrifugal actuator is blocked by said blocking arm, such that said braking portion of said centrifugal actuator is engaged with said braking member at said locked position.
